(19) United States
(12) Patent Application Publication
(10) Pub. No.: US 2015/0290760 A1
(43) Pub. Date: Oct. 15, 2015

(54) POLISHING COMPOSITION

(71) Applicant: FUJIMI INCORPORATED, Kiyosu-shi (JP)

(72) Inventors: Masayuki SERIKAWA, Kiyosu-shi (JP); Yasuhiro MOROE, Kiyosu-shi (JP); Toshimi MIZUTANI, Kiyosu-shi (JP); Reiko NAKAJIMA, Kiyosu-shi (JP)

(73) Assignee: FUJIMI INCORPORATED, Kiyosu-shi (JP)

(21) Appl. No.: 14/685,868

(22) Filed: Apr. 14, 2015

(30) Foreign Application Priority Data
Apr. 15, 2014 (JP) 2014-083834

(51) Int. Cl. B24B 1/00; C09G 1/02; B24B 7/22

(52) U.S. Cl. CPC B24B 1/00; B24B 7/22; C09G 1/02

(57) ABSTRACT

To provide a polishing composition which can polish a polishing object composed of a hard brittle material having the Vickers hardness of greater than 1,500 HV at a high polishing rate under a condition of a high polishing load (polishing pressure) of 150 g/cm² or more and can suppress the generation of a defect such as scratches on the surface of the polishing object or the generation of scratches on a polishing pad, a holding jig or the like when polishing a polishing object composed of a hard brittle material using a polishing apparatus having the polishing pad. The polishing composition contains abrasive grains, water and an additive agent that is adsorbed on the surface of the polishing pad to decrease unnecessary frictional resistance between the polishing pad and the polishing object.

### CROSS-REFERENCE TO RELATED APPLICATION

This application is based on Japanese Patent Application No. 2014-083834 filed on Apr. 15, 2014, the contents of which are incorporated herein by reference.

### BACKGROUND

1. Technical Field

The present invention relates to a polishing composition.

### 2. Description of Related Art

A single crystal of aluminum oxide or silicon carbide which is a so-called hard brittle material having the Vickers hardness of greater than 1,500 HV is used as a supporting substrate of LED and power semiconductor, and a single crystal substrate of aluminum oxide is also used in a cover glass of watch and the like due to its property to be hardly scratched.

Hitherto, polishing by a polishing composition containing colloidal silica at a high concentration has been conducted in order to highly flatten the crystal surface of the hard brittle material and thus to form a high-quality surface state (see JP 2008-44078 A).

However, since the crystal surface of the hard brittle material has a property to be hardly scratched, a polishing rate is significantly low and a long processing time is needed, and thus there are problems such as poor productivity and an increase of production cost.

There is a method to increase a polishing load (polishing pressure) in order to improve a polishing rate. The number of abrasive grains coming in contact with a polishing surface of a polishing object is increased under a high polishing load, and thus frictional force between the abrasive grains and the polishing surface becomes large, and the polishing efficiency is increased.

It is difficult to increase the polishing load in the case of a glass substrate used for a memory hard disk since scratches are likely to be caused on the surface of substrate by the friction generated when polishing under a high polishing load. However, a single crystal substrate composed of a hard brittle material of aluminum oxide or silicon carbide is polished under a high polishing load at enhanced polishing efficiency due to its hardness with property to be hardly scratched (see JP 2009-297818 A).

### SUMMARY OF INVENTION

However, there is a problem that a defect such as scratches is generated on the surface of substrate and the yield of products is lowered although the polishing rate is increased in the case of polishing a hard brittle material under a high polishing load as described in JP 2009-297818 A. In addition, there is also a problem that scratches are generated on a polishing pad, a holding jig or the like.

Accordingly, an object of the invention is to provide a polishing composition which can polish a polishing object composed of a hard brittle material having the Vickers hardness of greater than 1,500 HV at a high polishing rate under a condition of a high polishing load (polishing pressure) of 150 g/cm² or more and can suppress the generation of a defect such as scratches on the surface of the polishing object or the generation of scratches on the polishing pad, the holding jig or the like when polishing a polishing object composed of a hard brittle material using a polishing apparatus having a polishing pad.

The inventors conducted intensive researches in order to solve the above problems. As a result, it has been found that the above problems can be solved by the use of a polishing composition containing abrasive grains, water and an additive agent that is adsorbed on the surface of the polishing pad to decrease the unnecessary frictional resistance between the polishing pad and the polishing object when polishing a hard brittle material using a polishing apparatus having a polishing pad. Hence, the invention has been completed based on the above finding.

To achieve at least one of the above-mentioned objects, a polishing composition reflecting one aspect of the invention comprises the following.

The invention is a polishing composition which is used in the application to polish a polishing object composed of a hard brittle material having the Vickers hardness of greater than 1,500 HV under a polishing load of 150 g/cm² or more using a polishing apparatus having a polishing pad, comprising abrasive grains, water and an additive agent that is adsorbed on the surface of the polishing pad to decrease the unnecessary frictional resistance between the polishing pad and the polishing object.

### DESCRIPTION OF THE PREFERRED EMBODIMENTS

In one embodiment, the invention is a polishing composition which is used in the application to polish a polishing object composed of a hard brittle material having the Vickers hardness of greater than 1,500 HV under a polishing load of 150 g/cm² or more using a polishing apparatus having a polishing pad, comprising abrasive grains, water and an additive agent that is adsorbed on the surface of the polishing pad to decrease the unnecessary frictional resistance between the polishing pad and the polishing object. By this constitution, the polishing composition which can polish the polishing object at a high polishing rate and can suppress the generation of a defect such as scratches on the surface of the polishing object or the generation of scratches on the polishing pad, the holding jig or the like when polishing the polishing object composed of a hard brittle material using a polishing apparatus having a polishing pad is provided.

In general, the concentration of abrasive grains is high when polishing a polishing object composed of a hard brittle material and thus the abrasive grains provide a lubrication effect. However, it is considered that it is difficult for the abrasive grains to enter between the polishing surface of the polishing object and the polishing pad and thus the lubrication effect thereof is lost under a high polishing load (polishing pressure) condition, and the area in which the polishing object comes in contact with the polishing pad is also increased, and thus the so-called carrier noise is likely to be generated at the time of the double sided polishing. Strong friction is generated between the polishing object and the polishing pad under the polishing condition where the carrier noise occurs; therefore, there is a problem that a defect such as scratches may be generated on the surface of the polishing object or scratches may be generated on the polishing pad, the holding jig or the like.

In contrast, an additive agent that is contained in the polishing composition of the invention and adsorbed on face of the polishing pad to decrease the unnecessary frictional resistance between the polishing pad and the polishing object has at least an effect of adsorbing on the surface of the polishing pad and can further have an effect of adsorbing on the surface of the polishing object. It is considered that a space is formed between the polishing surface of the polishing object and the polishing pad by such additive agent. It is considered that the abrasive grains contained in the polishing composition easily enter the formed space and exert a lubricating effect, and thus the unnecessary frictional resistance (polishing resistance) between the polishing object and the polishing pad is decreased and a high polishing rate can be realized when polishing the polishing object composed of a hard brittle material having the Vickers hardness of greater than 1,500 HV using a polishing apparatus having a polishing pad under a condition of a polishing load of 150 g/cm² or more. Furthermore, it is considered that the generation of a defect such as scratches on the surface of the polishing object or the generation of scratches on the polishing pad, the holding jig or the like can be suppressed. The effect of the invention is more remarkably exerted as the polishing load is increased.

The above mechanism is a presumption, and thus the invention is not limited to the mechanism in any way.

### [Polishing Object]

The polishing composition of the invention can be used in the application to polish a polishing object composed of a hard brittle material having the Vickers hardness of greater than 1,500 HV, preferably 2,000 HV or more under a polishing load of 150 g/cm² or more using a polishing apparatus having a polishing pad. The Vickers hardness indicates the robustness to the pressing pressure and specifically is a hardness measured by the method described in JIS Z 2244: 2009.

Examples of such a hard brittle material may preferably include ceramics comprising an oxide such as silicon oxide, aluminum oxide, gallium oxide, and zirconium oxide; a nitride such as aluminum nitride, silicon nitride, and gallium nitride; and a carbide such as silicon carbide.

Among them, it is preferable that the polishing composition of the invention is used in the application to polish aluminum oxide, particularly sapphire that is a stable material against a chemical effect such as oxidation, complexation and etching. Furthermore, the polishing object to which the polishing composition of the invention is applied may be an object which is used in any application and may be a material for optical device, a material for power device and a compound semiconductor, for example. The form of the polishing object is not particularly limited and may be a substrate, a film or another molded body, but it is more preferably to be a molded body. In addition, the polishing object is more preferably a single crystal substrate composed of a hard brittle material from the viewpoint of fewer impurities.

In general, the frictional force by the abrasive grains is increased as the polishing load is increased, and the mechanical working force is improved; therefore the polishing rate is increased. The polishing load (polishing pressure) used for the polishing composition of the invention is 150 g/cm² or more, and preferably 200 g/cm² or more. A hard brittle material can be polished at a high polishing rate by using the polishing composition of the invention even under such a high polishing load and the generation of a defect such as scratches on the surface of the polishing object and the scratches on the polishing pad, the holding jig or the like can be suppressed.

Next, the constitution of the polishing composition of the invention will be described in detail.

### [Abrasive Grains]

The polishing composition of the invention contains abrasive grains.

Specific examples of the abrasive grains may include at least one member selected from the group consisting of silicon oxide (silica), aluminum oxide (alumina), zirconium oxide (zirconia), cerium oxide (ceria) and titanium dioxide (titania). Among these, silicon oxide (silica) and aluminum oxide (alumina) are preferable since they have advantages in terms that they are available with relative ease and it is easy to obtain a surface having high smoothness and fewer defects by polishing using a polishing composition. Colloidal silica is more preferable.

The abrasive grains may be surface-modified. Usual colloidal silica has a value of zeta potential close to zero under an acidic condition, and the silica particles are likely to aggregate without electrically repelling each other under an acidic condition. In contrast, the abrasive grains which are surface-modified so as to have a relatively large positive or negative value of zeta potential even under an acidic condition strongly repel each other even under an acidic condition to be favorably dispersed, and the storage stability of the polishing composition is improved as a result. Such surface-modified abrasive grains can be obtained, for example, by mixing a metal such as aluminum, titanium or zirconium or an oxide thereof with the abrasive grains to be doped on the surfaces of the abrasive grains.

Alternatively, the surface-modified abrasive grains in the polishing composition may be silica on which an organic acid is immobilized. Among them, colloidal silica on which an organic acid is immobilized can be preferably used. The immobilization of an organic acid to colloidal silica is performed by chemically bonding a functional group of an organic acid on the surface of colloidal silica. The immobilization of organic acid to colloidal silica cannot be accomplished by only allowing colloidal silica to simply coexist with an organic acid. It is possible to perform the immobilization, for example, by the method described in “Sulfonic acid-functionalized silica through quantitative oxidation of thiol groups”, Chem. Commun., 246-247 (2003) when sulfonic acid, a member of organic acids, is immobilized on colloidal silica. Specifically, it is possible to obtain colloidal silica having sulfonic acid immobilized on the surface thereof by coupling a silane coupling agent having a thiol group such as 3-mercaptopropyltrimethoxysilane to colloidal silica and then oxidizing the thiol group with hydrogen peroxide. Alternatively, it is possible to perform the immobilization, for example, by the method described in “Novel Silane Coupling Agents Containing a Photolabile 2-Nitrobenzyl Ester for Introduction of a Carboxy Group on the Surface of Silica Gel”, Chemistry Letters, 3, 228-229 (2000) when carboxylic acid is immobilized on colloidal silica. Specifically, it is possible to obtain colloidal silica having carboxylic acid immobilized on the surface thereof by coupling a silane coupling agent containing a photoreactive 2-nitrobenzyl ester to colloidal silica and then irradiating with light.

The abrasive grains may be used singly or as a mixture of two or more members. In addition, the abrasive grains may be a commercially available product or a synthetic product.

In addition, the abrasive grains may have a spherical shape or a non-spherical shape. Specific examples of the non-spherical shape may include various shapes including a polygonal pole shape such as a triangle pole and a square pole, a cylindrical shape, a bale shape in which the central portion of the cylinder is bulged more than the end portion, a donut shape in which the central portion of the disk is penetrated, a plate shape, the so-called cocoon shape having a narrow part in the central portion, the so-called confetti shape having a plurality of protrusions on the surface thereof and a rugby ball shape, and the non-spherical shape is not particularly limited.

The average primary particle size of the abrasive grains contained in the polishing composition is preferably 5 nm or more, more preferably 10 nm or more and even more preferably 20 nm or more. The polishing rate of the polishing object by the polishing composition is improved as the average primary particle size of the abrasive grains is increased.

The average primary particle size of the abrasive grains contained in the polishing composition is preferably 2 or less, more preferably 500 nm or less and even more preferably 200 nm or less. It is easy to obtain a surface having fewer defects and low roughness by polishing using the polishing composition as the average primary particle size of the abrasive grains is decreased. The value of the average primary particle size of the abrasive grains is calculated from the specific surface area of the abrasive grains, for example, measured by the BET method. The measurement of the specific surface area of the abrasive grains can be performed, for example, using the “Flow Sorb II 2300” manufactured by Micromeritics.

The lower limit value of the content of the abrasive grains in the polishing composition is preferably 0.01% by mass or more and more preferably 0.1% by mass or more. The polishing rate of the polishing object by the polishing composition is improved as the content of the abrasive grains is increased.

In addition, the upper limit value of the content of the abrasive grains in the polishing composition is preferably 50% by mass or less and more preferably 40% by mass or less. It is easy to obtain a surface having fewer defects such as scratches by polishing using the polishing composition in addition to that the production cost of the polishing composition is cut down as the content of the abrasive grains is decreased.

### [Water]

The polishing composition of the invention contains water as a dispersion medium or solvent for dispersing or dissolving each component. Water not containing impurities as much as possible is preferable from the viewpoint of suppressing to inhibit an effect of other components, and specifically, pure water, ultrapure water or distilled water, from which impurity ions are removed by an ion exchange resin and then foreign substances are removed through a filter, is preferable.

### [Additive Agent]

The additive agent that is adsorbed on the surface of the polishing pad to decrease the unnecessary frictional resistance between the polishing pad and the polishing object can have a function to be adsorbed at least on the surface of the polishing pad and further on the surface of the polishing object. This additive agent works to suppress the direct contact of the polishing object with the polishing pad and thus to decrease the unnecessary frictional resistance (polishing resistance) between the polishing pad and the polishing object. It is possible to polish a polishing object composed of a hard brittle material having the Vickers hardness of greater than 1,500 HV at a high polishing rate under a condition of a high polishing load (polishing pressure) of 150 g/cm² or more and to suppress the generation of a defect such as scratches on the surface of the polishing object or the scratches on the polishing pad, the holding jig or the like when polishing a polishing object composed of a hard brittle material using the polishing composition of the invention containing such an additive agent and a polishing apparatus having a polishing pad.

The additive agent according to the invention is at least one member selected from the group consisting of an anionic surfactant and an anionic water-soluble polymer.

Specific examples of the anionic surfactant used as the additive agent may include an alkyl sulfate ester salt such as sodium lauryl sulfate, ammonium lauryl sulfate, sodium stearyl sulfate and sodium cetyl sulfate; a polyoxyalkylene alkyl ether acetate such as sodium polyoxyethylene tridecyl ether acetate; an alkylbenzenesulfonate such as sodium dodecylbenzenesulfonate; a polyoxyalkylene alkyl ether sulfuric acid and a polyoxyalkylene alkyl ether sulfate; a higher fatty acid amide sulfonate such as sodium stearoyl methyl taurate, sodium lauroyl methyl taurate, sodium myristoyl methyl taurate and sodium palmitoyl methyl taurate; a N-acyl sarcosinate such as sodium lauroyl sarcosinate; an alkyl phosphate such as sodium monostearyl phosphate; a polyoxyalkylene alkyl ether phosphoric ester salt such as sodium polyoxyethylene oleyl ether phosphate and sodium polyoxyethylene stearyl ether phosphate; a phosphonate such as a polyoxyethylene styrylphenyl ether phosphonate and a lauryl ether phosphonate; a long chain sulfosuccinate such as sodium di-2-ethylhexyl sulfosuccinate and sodium dioctyl sulfosuccinate; and a long-chain N-acyl glutamate such as monosodium N-lauroyl glutamate and disodium N-stearoyl-L-glutamate.

In addition, examples of the anionic water-soluble polymer used as the additive agent may include a copolymer of palmitic acid, oleic acid, linoleic acid, linolenic acid, docosahexaenoic acid, polyacrylic acid, polymethacrylic acid, polymaleic acid, polymaleic anhydride or maleic acid and isobutylene, a copolymer of maleic anhydride and isobutylene, a copolymer of maleic acid and diisobutylene, a copolymer of maleic anhydride and diisobutylene, a copolymer of acrylic acid and itaconic acid, a copolymer of methacrylic acid and itaconic acid, a copolymer of maleic acid and styrene, a copolymer of maleic anhydride and styrene, a copolymer of acrylic acid and methacrylic acid, a copolymer of acrylic acid and acrylic acid methyl ester, a copolymer of acrylic acid and vinyl acetate, a copolymer of acrylic acid and maleic acid, a copolymer of acrylic acid and maleic anhydride, and an alkali metal salt (lithium salt, sodium salt, potassium salt and the like), a salt of Group 2 elements (magnesium salt, calcium salt and the like) and a polycarboxylate salt (an ammonium salt, an amine salt and the like) thereof; a formalin condensate of an alkyl diphenyl ether disulfonic acid, naphthalenesulfonic acid, alkylnaphthalenesulfonic acid, or naphthalenesulfonic acid, a formaldehyde condensate of alkyl naphthalenesulfonic acid, and an alkali metal salt (lithium salt, sodium salt, potassium salt and the like), a salt of Group 2 elements (magnesium salt, calcium salt and the like) and a naphthalenesulfonate salt ammonium salt, amine salt and the like) thereof; a formalin condensate of polystyrene sulfonic acid, melamine sulfonic acid, alkyl melamine sulfonic acid, or melamine sulfonic acid, a formalin condensate of alkyl melamine sulfonic acid, and an alkali metal salt (lithium salt, sodium salt, potassium salt and the like), a salt of Group 2 elements (magnesium salt, calcium salt and the like) and a sulfonate salt (ammonium salt, amine salt and the like) thereof; and polyvinyl alcohol.

The above additive agents may be used singly or in combination of two or more members. Among these, the additive agent preferably has at least one member of functional group selected from the group consisting of a phosphoric acid group, a phosphonic acid group, a sulfuric acid group, a sulfonic acid group, a carboxyl group, a hydroxyl group and a salt thereof since they have a structure to be easily ionized in the backbone. The additive agent is more preferably an alkylbenzenesulfonic acid, naphthalenesulfonic acid, polystyrene sulfonic acid, polysulfonic acid, polyvinyl alcohol and a salt or condensate thereof. More specific examples of the additive agent may suitably include sodium decylbenzenesulfonate, sodium dodecylbenzenesulfonate, sodium tetradecylbenzenesulfonate, sodium polystyrene sulfonate, a formalin condensate of naphthalenesulfonic acid and polyvinyl alcohol.

The weight average molecular weight of the additive agent that is contained in the polishing composition and adsorbed on the surface of the polishing pad to decrease the unnecessary frictional resistance between the polishing pad and the polishing object is preferably 200 or more and more preferably 300 or more. The polishing rate is highly maintained as the weight average molecular weight of the additive agent is increased.

The weight average molecular weight of the additive agent that is adsorbed on the surface of the polishing pad to decrease the unnecessary frictional resistance between the polishing pad and the polishing object is preferably 1,500,000 or less, more preferably 1,000,000 or less and even more preferably 500,000 or less. The frictional resistance (polishing resistance) between the polishing pad and the polishing object is decreased as the weight average molecular weight of the additive agent is decreased.

Moreover, among the above additive agents, the weight average molecular weight of the anionic surfactant is preferably 5,000 or less and more preferably 2,000 or less.

Among the above additive agents, the weight average molecular weight of the anionic water-soluble polymer is employed the value measured by gel permeation chromatography (GPC) using polystyrene as a standard substance.

In addition, among the above additive agents, the weight average molecular weight of the anionic surfactant is employed the value measured by high performance liquid chromatography (HPLC).

The content of the additive agent that is adsorbed on the surface of the polishing pad to decrease the unnecessary frictional resistance between the polishing pad and the polishing object in the polishing composition is preferably 0.0001% by mass or more, more preferably 0.0005% by mass or more and even more preferably 0.001% by mass or more. A protective film enough to suppress friction is likely to be formed on the surface of the polishing obj ect as the content of the additive agent in the polishing on increased, and thus the carrier noise during polishing is decreased and the generation of a defect such as scratches on the surface of the polishing object and the scratches on the polishing pad, a holding jig or the like can be suppressed.

In addition, the content of the additive agent in the polishing composition is preferably 0.5% by mass or less, more preferably 0.2% by mass or less and even more preferably 0.1% by mass or less. A decrease in the polishing rate of the polishing object by the protective film is further suppressed as the content of the additive agent in the polishing composition is decreased.

### [Other Components]

The polishing composition of the invention may further contain other components such as an additive agent for further increasing the polishing rate including a pH adjusting agent, a complexing agent, an etching agent and an oxidant, an additive agent that imparts hydrophilicity and dispersion effect on the surface of the hard brittle material, a preservative agent, an antifungal agent, a corrosion inhibitor, a chelating agent, a dispersant to improve the dispersibility of abrasive grains and a dispersion auxiliary agent to facilitate the redistribution of the aggregate of abrasive grains if necessary.

Hereinafter, the pH adjusting agent, the preservative agent and the antifungal agent which are preferred as other components will be described.

### [pH Adjusting Agent]

The polishing composition of the invention preferably contains a pH adjusting agent. The pH adjusting agent adjusts the pH of the polishing composition, which makes it possible to control the polishing rate of the hard brittle material, the dispersibility of the abrasive grains and the like. The pH adjusting agent may be used singly or as a mixture of two or more members.

As the pH adjusting agent, it is possible to use an acid, a base or a salt thereof which is known in the art.

The addition amount of the pH adjusting agent is not particularly limited and may be suitably adjusted so that the polishing composition has a desired pH.

The lower limit of the pH of the polishing composition of the invention is preferably 7 or more and more preferably 8 or more. The dispersibility of the abrasive grains is improved as the pH of the polishing composition is increased.

In addition, the upper limit of the pH of the polishing composition of the invention is preferably 14 or less and more preferably 13 or less. The dispersibility of the abrasive grains, the safety and economic efficiency of the composition and the like is further improved as the pH of the polishing composition is decreased.

### [Preservative Agent and Antifungal Agent]

Examples of the preservative agent and antifungal agent used in the invention may include an isothiazolin-based preservative agent such as 2-methyl-4-isothiazolin-3-one and 5-chloro-2-methyl-4-isothiazolin-3-one, a paraoxybenzoate esters and phenoxyethanol. These preservative agents and anti fungal agents may be used singly or as a mixture of two or more members.

### [Method for Producing Polishing Composition]

A method for producing a polishing composition of the invention is not particularly limited, and for example, the polishing composition can be obtained by mixing abrasive grains, an additive agent that is adsorbed on the surface of a polishing pad to decrease unnecessary frictional resistance between a polishing pad and a polishing object and other components if necessary in water through stirring.

The temperature at the time of mixing the respective components is not particularly limited and is preferably from 10 to 40° C. and heating may be performed in order to increase the dissolution rate. In addition, the mixing time is also not particularly limited.

### [Method for Producing Polished Polishing Object]

As described above, the polishing composition of the invention is suitably used in polishing a polishing object composed of a hard brittle material having the Vickers hardness of more than 1,500 HV. Hence, the invention provides a method for producing a polished polishing object including a step of polishing a polishing object composed of a hard brittle material having the Vickers hardness of greater than 1,500 HV under a polishing load of 150 g/cm² or more using the polishing composition of the invention and a polishing apparatus having a polishing pad. The polishing object is preferably a single crystal substrate or molded body made of sapphire.

It is possible to conduct polishing using a polishing apparatus having a polishing pad and a polishing condition which are used in polishing a usual hard brittle material when polishing a hard brittle material using the polishing composition of the invention. There are a single sided polishing apparatus and a double-sided polishing apparatus as a general polishing apparatus. In the case of a single sided polishing apparatus, a substrate is held using a holder called carrier, a polishing table on which a polishing cloth (polishing pad) is pasted is pressed against one side of the substrate and rotated while supplying the polishing composition, thereby polishing one side of the hard brittle material. In the case of a double-sided polishing apparatus, a substrate is held using a holder called carrier, a polishing table on which a polishing cloth (polishing pad) is pasted is pressed against the facing surface of the substrate and they are rotated in the relative direction while supplying the polishing composition from above, thereby polishing both sides of the hard brittle material. At this time, polishing is conducted by physical effect due to friction among the polishing pad, the polishing composition and the hard brittle material and chemical effect on the hard brittle material caused by the polishing composition.

As the polishing condition in the polishing method according to the invention, a linear velocity in polishing is mentioned. In general, the linear velocity is affected by, for example, the rotation number of polishing pad, the rotation number of carrier, the size of substrate and the number of substrates; however, the frictional force applied to the substrate is large when the linear velocity is high, and thus the effect of mechanically polishing the edge is large. In addition, there is a case in which frictional heat is generated by friction and thus the chemical effect by the polishing composition may be large. The linear velocity in the polishing method according to the invention is not particularly limited; however, it is preferably from 10 to 300 m/min and more preferably 25 to 200 m/min. There is a case in which a sufficient polishing rate cannot be obtained when the linear velocity is low. In addition, when the linear velocity is high, there is a case in which the polishing pad is damaged by the friction of substrate or on the contrary, there is a case in which the friction is not sufficiently transmitted to the substrate, the substrate is in the so-called slipping state, and it is not sufficiently polished.

The polishing pad used in the polishing method of the invention is not particularly limited, and examples thereof may include a polyurethane type, a nonwoven fabric type and a suede type which are different in the property of material, those which are different in physical properties such as hardness and thickness, and those which contain abrasive grains or those which do not contain abrasive grains, and any of these pads may be used.

As the polishing condition in the polishing method according to the invention, the supply amount of the polishing composition is mentioned. The supply amount varies depending on the kind of substrate to be polished, polishing apparatus or polishing conditions; however, the amount of the polishing composition may be enough for being uniformly supplied to the entire surface between the polishing object and the polishing pad. There is a case in which the polishing composition is not supplied to the entire substrate or the composition dries and coagulates to cause a defect on the surface of substrate when the supply amount of the polishing composition is small. On the contrary, when the supply amount is large, it is not economical and friction is interfered by the excess polishing composition, particularly the medium such as water and thus polishing may be inhibited.

Each component contained in the polishing composition of the invention may be filtered through a filter immediately prior to the polishing composition production. In addition, the polishing composition of the invention may be used by being filtered through a filter immediately prior to the use. The coarse foreign matters in the polishing composition are removed and thus the quality of the polishing composition is improved by providing the filtration treatment.

It is possible to collect the polishing composition which is once used for polishing and to use it again for polishing when polishing a hard brittle material using the polishing composition of the invention. As an example of the method to reuse the polishing composition, a method is mentioned in which the polishing composition discharged from the polishing apparatus is collected in a tank and then circulated again to the polishing apparatus to be used. The cyclic use of the polishing composition is useful in terms that the environmental burden can be decreased since the amount of polishing composition to be discharged as the effluent is decreased and the production cost for polishing the hard brittle material can be suppressed since the amount of the polishing composition to be used is decreased.

At the time of the cyclic use of the polishing composition of the invention, a part or all of the abrasive grains, the additive agent that is adsorbed on the surface of the polishing pad to decrease the unnecessary frictional resistance between the polishing pad and the polishing object and other additive agents which have been consumed and lost by polishing can be added as a composition adjusting agent during the cyclic use. In this case, a part or all of the abrasive grains, the additive agent that is adsorbed on the surface of the polishing pad to decrease the unnecessary frictional resistance between the polishing pad and the polishing object and other additive agents may be mixed together in an arbitrary mixing ratio as the composition adjusting agent. The polishing composition is adjusted to a composition suitable to be reused and polishing is suitably maintained by additionally adding the composition adjusting agent. The concentrations of the abrasive grains, the additive agent that is adsorbed on the surface of the polishing pad to decrease the unnecessary frictional resistance between the polishing pad and the polishing object and other additive agents contained in the composition adjusting agent are arbitrary and are not particularly limited; however it is preferable that the concentrations be appropriately adjusted depending on the size of a circulation tank and the polishing conditions.

The polishing composition of the invention may be a one-pack type or a multi-pack type including a two-pack type in which a part or all of the polishing composition is mixed in an arbitrary mixing ratio. In addition, it is possible to use two or more polishing compositions which are adjusted in advance so as to be mixed on the polishing apparatus in the case of using a polishing apparatus having a plurality of supply paths for the polishing composition.

In addition, the polishing composition of the invention may be prepared by diluting a stock solution of polishing composition with water. In a case in which the polishing composition is a two-pack type, the order of mixing and dilution is arbitrary and examples thereof may include a case in which one composition is diluted with water and then mixed with the other composition, a case in which the two compositions are mixed together and diluted with water at the same time, and a case in which the mixed polishing composition is diluted with water.

### Examples

The invention will be described in more detail with reference to the following Examples and Comparative Examples. However, the technical scope of the invention is not limited to only the following Examples.

### (Preparation of Polishing Composition)

Colloidal silica sol containing colloidal silica having an average primary particle size of 20 nm was diluted with water and an additive agent that was adsorbed on the surface of a polishing pad to decrease unnecessary frictional resistance between a polishing pad and a polishing object and presented in the following Table 1 was added thereto, whereby the polishing compositions of Examples 1 to 8 and Comparative Examples 1 to 6 were prepared. In all of the polishing compositions of Examples 1 to 8 and Comparative Examples 1 to 5, the content of colloidal silica was 20% by mass and the content of the additive agent that was adsorbed on the surface of the polishing pad to decrease the unnecessary frictional resistance between the polishing pad and the polishing object was 0.01% by mass. In addition, Comparative Example 6 was the control and thus a polishing composition which had a content of colloidal silica of 20% by mass and did not contain the additive agent that was adsorbed on the surface of the polishing pad to decrease the unnecessary frictional resistance between the polishing pad and the polishing object was prepared.

### (Measurement of Polishing Rate and Carrier Noise)

A surface of a sapphire substrate (A plane (<1120>, Vickers Hardness: 2300 HV) was polished using the polishing compositions of Examples 1 to 8 and Comparative Examples 1 to 6 under the following polishing condition. All of the sapphire substrates used were the same member having a diameter of 52 mm (about 2 inches).

### <Polishing Condition of Sapphire Substrate>

Polishing machine: double-sided polishing machine 6BN (manufactured by HAMAI CO., LTD.)

Polishing cloth (polishing pad): non-woven pad SUBA800 manufactured by Nitta Haas Incorporated

Polishing object: sapphire substrate A plane 2 inch disk

Number of carriers: (1 sheet/1 carrier)×3 carriers

Load: 300 g/cm²

Rotational speed: 40 rpm

Supply amount of polishing composition: 200 mL/min (cyclic use)

Polishing time: 60 minutes

After polishing by using the polishing composition of each of Examples and Comparative Examples, the mass of the sapphire substrate was measured, the polishing rate was determined from the difference in mass before and after polishing, and the ratio was determined when the polishing rate in the case of the polishing composition which did not contain the additive agent that was adsorbed on the surface of the polishing pad to decrease the unnecessary frictional resistance between the polishing pad and the polishing object of Comparative Example 6 was 1.

In addition, a carrier noise was measured under the following condition and evaluated according to the criteria presented in Table 1.

### <Carrier Noise Measurement Condition>

Measuring instrument: SOUND LEVEL METER SM-325 (manufactured by AS ONE Corporation)

Measuring range: 50 to 100 dB

Frequency characteristics: C characteristics

Distance from polishing machine to measuring instrument: 100 cm

TABLE 1

| | Time having noise of 80 dB or more |
|---|---|
| Judgment | (sec/1 minute of polishing) |
| ○ | Less than 10 |
| Δ | 10 or more and less than 30 |
| × | 30 or more |

Judgment based on the noise (maximum: 76 dB) of polishing by which carrier noise is not generated

The results of each evaluation are presented in the following Table 2.

TABLE 2

| | Additive agent that is | | |
|---|---|---|---|
| | adsorbed on surface of | | |
| | polishing pad to decrease | | |
| | unnecessary frictional | | |
| | resistance between | | |
| | polishing pad and | Polishing | Carrier |
| | polishing object | rate | noise |
| Example 1 | Sodium | 0.8 | ○ |
| | decylbenzensulfonate | | |
| | (Mw:320.4) | | |
| Example 2 | Sodium | 0.8 | ○ |
| | dodecylbenzensulfonate | | |
| | (Mw:348.5) | | |
| Example 3 | Sodium | 0.7 | Δ |
| | tetradecylbenzensulfonate | | |
| | (Mw:376.5) | | |
| Example 4 | Sodium polystyrene | 0.8 | ○ |
| | sulfonate | | |
| | (Mw:60000) | | |
| Example 5 | Sodium polystyrene | 0.8 | Δ |
| | sulfonate | | |
| | (Mw:1200000) | | |
| Example 6 | Formalin condensate of | 0.9 | Δ |
| | naphthalenesulfonic acid | | |
| | (Mw:10000) | | |
| Example 7 | Polyvinyl alcohol | 1 | Δ |
| | (Mw:75000) | | |
| Example 8 | Polyvinyl alcohol | 1 | Δ |
| | (Mw:115000) | | |
| Comparative | Polyether polyol | 1 | × |
| Example 1 | urethane polymer | | |
| | (Mw:20000) | | |
| Comparative | Polyvinylpyrrolidone | 0.8 | × |
| Example 2 | (Mw:45000) | | |
| Comparative | Cellulose | 0.5 | × |
| Example 3 | (Mw:30000) | | |
| Comparative | Tamarind gum | 1 | × |
| Example 4 | (Mw:470000) | | |
| Comparative | Polyoxyethylene | 1 | × |
| Example 5 | alkyl ether | | |
| | (Mw:300000) | | |
| Comparative | Nil | 1 | × |
| Example 6 | | | |

As it is apparent from Table 2, it has been found that it is possible to polish a polishing object at a high polishing rate in the case of using the polishing compositions of Examples 1 to 8. In addition, it has been found that the carrier noise is low and thus the generation of a defect such as scratches on the surface of the polishing object or the scratches on the polishing pad, the holding jig or the like can be suppressed in the case of using the polishing compositions of Examples 1 to 8.

In the polishing compositions of Comparative Examples 1 to 6, the carrier noise is high and thus the generation of a defect such as scratches on the surface of the polishing object or the scratches on the polishing pad, the holding jig or the like have been implied. In the case of the polishing composition using cellulose of Comparative Example 3, the polishing rate is also low.

1. A polishing composition which is used for polishing a polishing object composed of a hard brittle material having Vickers hardness of greater than 1,500 HV under a polishing load of 150 g/cm² or more using a polishing apparatus having a polishing pad, comprising:
abrasive grains;
water; and
an additive agent that is adsorbed on a surface of the polishing pad to decrease unnecessary frictional resistance between the polishing pad and the polishing object.

2. The polishing composition according to claim 1, wherein the additive agent is at least one member selected from the group consisting of anionic surfactants and anionic water-soluble polymers.

3. The polishing composition according to claim 1, wherein the additive agent has at least one functional group selected from a group consisting of a phosphoric acid group, a phosphoric acid group, a sulfuric acid group, a sulfonic acid group, a carboxyl group, a hydroxyl group and salts thereof.

4. The polishing composition according to claim 1, wherein the additive agent comprises at least one member selected from the group consisting of alkylbenzenesulfonic acid, naphthalenesulfonic acid, polysulfonic acid, polyvinyl alcohol and salts or condensates thereof.

5. A method for producing a polished polishing object, comprising:
a step of polishing a polishing object composed of a hard brittle material having Vickers hardness of greater than 1,500 HV under a polishing load of 150 g/cm² or more using the polishing composition set forth in claim 1 and a polishing apparatus having a polishing pad.

6. The method according to claim 5, wherein the polishing object is a single crystal substrate or molded body formed of sapphire.
